(19) United States
(12) Patent Application Publication
(10) Pub. No.: US 2015/0037109 A1
(43) Pub. Date: Feb. 5, 2015

(54) AUXILIARY DEVICE FOR DRILLING MACHINES WITH DIRECTED AIR JET

(71) Applicant: Rafael Francisco Furtan DANTAS, (US)

(72) Inventor: Rafael Francisco Furtan Dantas, Jacarei/SP (BR)

(21) Appl. No.: 14/390,674

(22) PCT Filed: Apr. 2, 2013
(86) PCT No.: PCT/BR2013/000274

§ 371 Date: Oct. 3, 2014

(30) Foreign Application Priority Data
Apr. 3, 2012 (BR) 20 2012 007629 8

(51) Int. Cl. B23B 47/34; B23B 45/04; B23Q 11/00; B23B 45/00

(52) U.S. Cl. CPC B23B 47/34; B23B 45/003; B23B 45/04; B23Q 11/005; B23B 2270/30; B23B 2270/027
USPC 408/56

(57) ABSTRACT

Auxiliary device for directed air power drills essentially consists of a device (1) connected to the exhaust (2) of pneumatic tools (3) with a duct that (4) directs airflow (A) in the direction of the cutting, drilling or reaming elements (5)/micrometer body (6), removing the residues and consequently increasing the useful life of such elements and improving task ergonomics with a substantial reduction in operation time.

This is a request for Model of Utility Patent for an innovative and practical auxiliary device for directed air power drills—notably for a device attached to the output of pneumatic drills that serves as a conduit for exhaust air, which is directed to the region where the reaming or drilling is being done, thus removing residue/chips on behalf of greater useful life of the cutting element and accessories, such as, the reamer and the micrometer body.

The preferred field of application for the innovation is the aerospace industry, especially for affixing aircraft panels and components, in which it is necessary to conduct drilling and precision reaming, and which may be extended to structural assemblies and similar.

The aeronautical industry is a segment in which the precision of any assembly and/or process is fundamental for aircraft safety and operation, and therefore, every day manufacturers develop new technologies/processes/equipment and devices geared toward that purpose.

More specifically, in conformity with the focus of this petition for a patent, in the manufacturing and assembly of aircraft, drilling for affixing and/or union of fuselage parts and panels, etc., require precision of, at least, hundredths of millimeters. In order to meet this requirement, the drilling is done with the gradual opening of the diameters using progressively larger drill bits. After drilling the holes, the process moves on to the reaming phase with the purpose of discretely receiving rivet and screw heads.

Therefore, the drilling and the reaming is done in several phases, especially in the drilling in which it is required to control depth and the adjustment of centralization. The reaming on the other hand demands fewer phases.

More technically, for reaming a cutting element similar to a drill bit is used. In precision drilling, the reamer is used together with the micrometer body with the objective of controlling reaming depth at the measurement required for rivet or screw. The depth and/or dimension of the reaming is calibrated by adjusting a drum with a micrometer scale, and this micrometer body is affixed to the drill mandrill, with the reamer inside, and with the course measured for that depth. In order to make the aforementioned functionalities feasible, the micrometer body has bearings in its construction, which should be conserved and spared from any attack by residues by shielding it or by reducing dust volume.

In general, the drilling process is conducted as per the following steps: the operator begins drilling with a bit that has a smaller diameter than nominal diameter for the hole, which will gradually be enlarged using progressively bigger bits until the project specification size is the required precision. In this interim, the operator tries to visualize orifice depth and its diameter by conducting measurements using a comparison meter of making checks with a specific screw for each assembly.

For such, the region or hole should be residue free, because otherwise, the dimension means could be induced to error. One means to clean the area is for the operator to direct the power drill's exhaust air along its handle, which demands repetitive rotation and translation movements by the wrist to “sweep” the entire surface of generated residue.

Likewise, but with fewer checks, reaming also uses cleaning the region by directing exhaust air from the power drill, incurring the same ergonomic inconvenience resulting from the rotation and translation movements of the operator's wrist. That is because the residues generated in the cut disturb the view and the verification of conformity, or not, of the ream.

Furthermore, it should be underscored that in the case of reaming, the residue and dirt stemming from thinning of the material directly hamper the micrometer body mechanism, especially the bearings.

Thus, during operation of the drill, and after reaming, there will invariably be penetration of of residue and chips, causing it to lock.

The current state of the technique anticipates some patent documents that talk about the matter in question, such as MU 8400232-8 “ACCESSORY FOR COLLECTING DEBRIS RESULTING FROM ELECTRIC DRILL ACTION”, consisting of a mechanical accessory that attaches to several models of electric drills to collect and hold the debris resulting from the action of these in a collection chamber, having, besides this function, also the functions of aspirating and blowing, comprised of several attachable accessories in the electric drills

The above document points to a solution for assisting in the removal of the residue generated in the drilling processes; however, for the issue of removing such by blowing as claimed by the document above, the place for capturing this air is along the contiguous tear line at the fan, in a “U” shaped support that channels the flow through a small output duct which is inefficient for the efficacy of the removal task. Furthermore, the solution is also ergonomically precarious since the operator must stop drilling and direct the airflow by spinning and translating the operator's wrist and arm, pulling the tool away to position the tip directly over the drill hole, thus increasing task time and possibly leading to some sort of Repetitive Motion Injury (RMI).

In short, the current state of the technique presents the following main limitations:
Due to conventional techniques, the operations demand a long time for drilling holes and reaming;
In the reaming operation, it causes irreparable harm to the micrometer boy due to contact with residue, chips and dust;
Accentuates premature wear in the ream cut, shortening its useful life, as well as the drill bit's useful life;
It demands great effort by the operator due to excess wrist (hand) movement, contributing significantly to the appearance of RMI.

With the purpose of solving the aforementioned problems, as well as to present an economically feasible solution for production, the inventor, a professional tied to the sector in question, idealized the auxiliary device for directed air power drills, which, along general lines can be defined as an auxiliary device for directing the air from the exhaust of the pneumatic drill, through a duct that flows over the cutting element, drill bit or reamer, thus removing any residue from the surface of the piece, from the cutting element and from the micrometer body itself.

Preferably, in order to enable the innovation, the device has a duct attached to the exhaust output through a gasket that expands in its cavity when providing torque to a nut external to the aforementioned output.

In order to meet the different operational and practical needs of use and place to be drilled and reamed, the device may have the duct bent and directed with the air output to the left, or to the right, upward or downward in relation to the cutting element or the micrometer body.

Conceptually, this innovation takes advantage of the construction of a pneumatic tool for drilling or reaming purposes, where the airflow from the drill exhaust exempts the operator from the repetitive task of removing the tool and systematically rotating it and translating it in order to remove the residue, thus providing for greater productivity.

As a means to show the efficiency of this solution, comparison tests were conducted between the innovation and the conventional model. The results are shown above, measuring the execution time for the following operation: Make 60 reamed holes—timed:
1st using the conventional reamer drill, execution was timed at 6′: 36″ for 60 holes;
2nd, using the innovation device for the same number of holes, execution time was 3′: 16″.

It was thus concluded that there was a 100% gain in productivity since the execution time was reduced because wrist and arm movements were not required.

In short, the innovation deposited herein has the following major advantages:
It offers optimal ergonomic appeal in drilling and reaming activities, avoiding the appearance of RMI;
It is the only truly ergonomic device for this application;
It provides for productivity gains in excess of 100% due to the activity being executed without breaks;
It increases the useful life of the micrometer body and drill bits avoiding the accumulation of residue or dust as it continuously cleans;
Functionality and practicality—extrapolates the basic objective of hole reaming, enabling an unprecedented means to do so;
Easy to use, with an excellent cost×benefit ratio.
Reduced manufacturing cost—simple construction and availability of materials in the market.

Below, the functional, aesthetic and structural particularities of the innovation are explained, with reference to the attached drawings, in which they are represented in an illustrative but not limited manner:

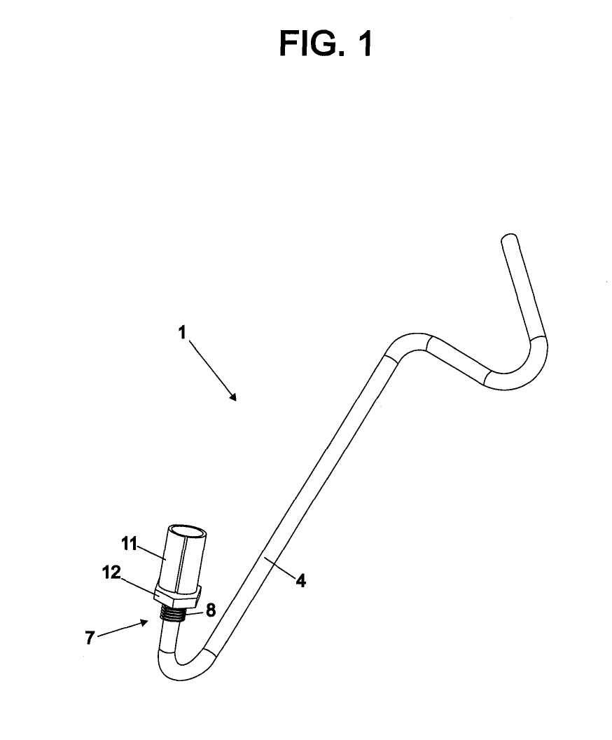

FIG. 1: Perspective view of the auxiliary airflow device applied to pneumatic drills;

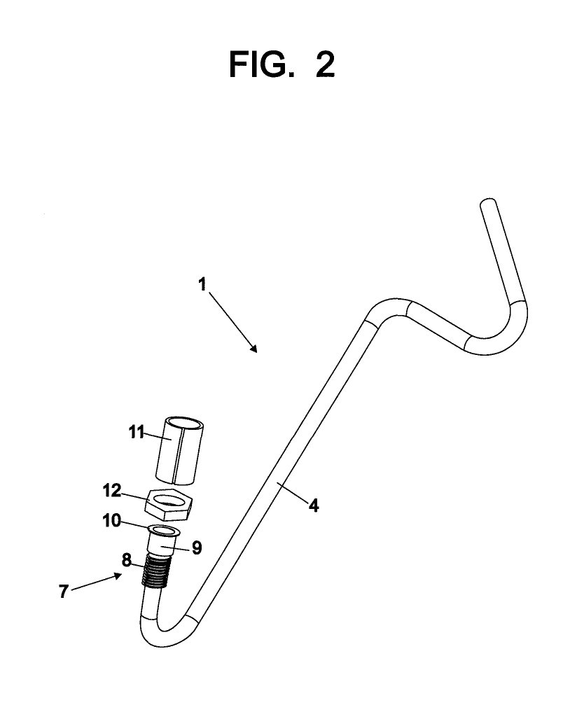

FIG. 2: Exploded perspective view of the auxiliary airflow device applied to pneumatic drills and reamers;

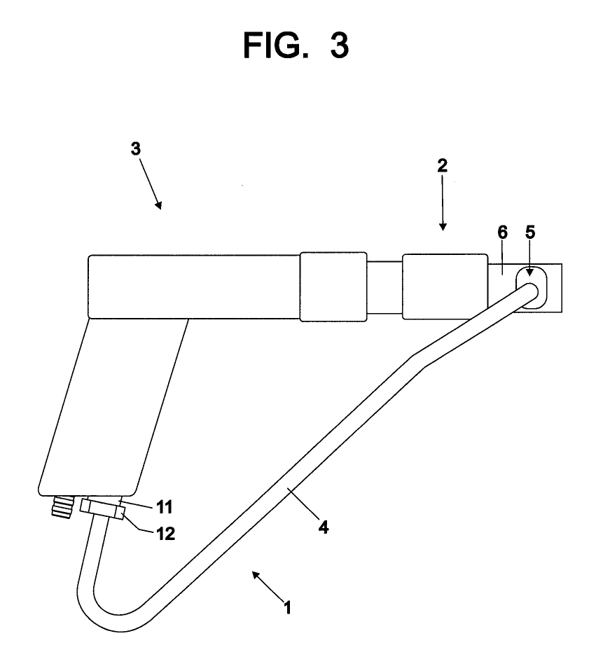

FIG. 3: Lateral view of the auxiliary airflow device, innovated and mounted on a pneumatic drill equipped with a micrometer body and a reamer;

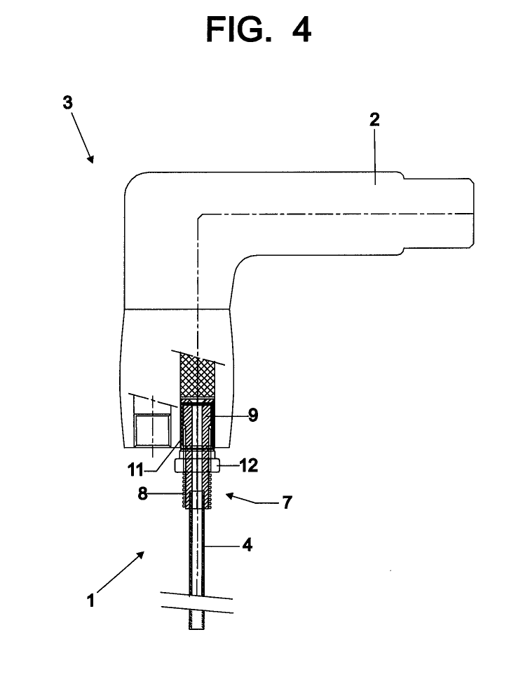

FIG. 4: Lateral cut view of the auxiliary airflow device, innovated and mounted on a pneumatic drill equipped with a micrometer body and a reamer;

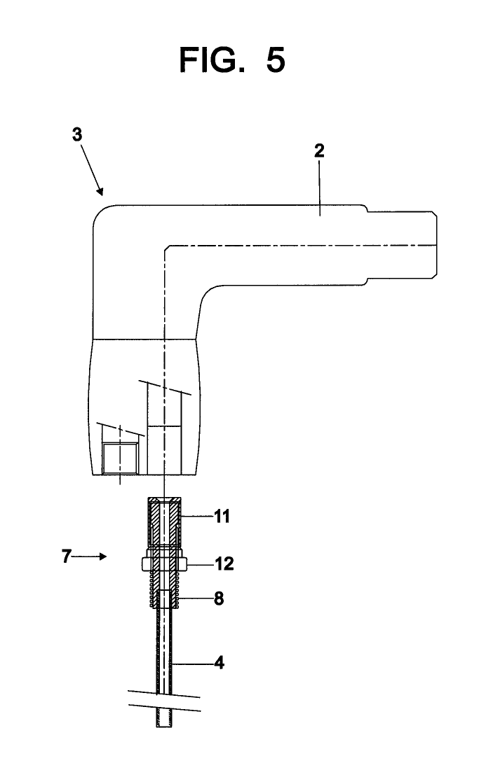

FIG. 5: Lateral exploded view of the auxiliary airflow device, innovated and mounted on a pneumatic drill equipped with a micrometer body and a reamer;

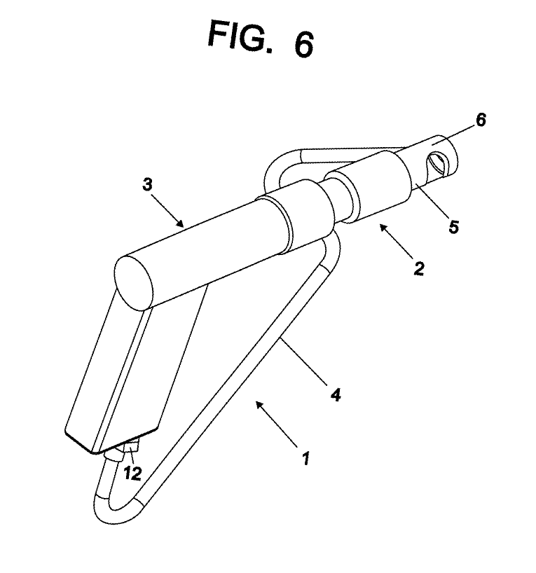

FIG. 6: Perspective view of the auxiliary airflow device, innovated and mounted on a pneumatic drill equipped with a micrometer body and a reamer, with air output to the left of the tool;

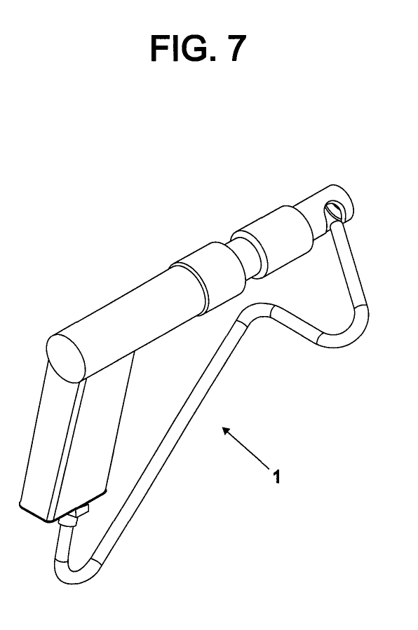

FIG. 7: Perspective view of the auxiliary airflow device, innovated and mounted on a pneumatic drill equipped with a micrometer body and a reamer, with air output to the right of the tool;

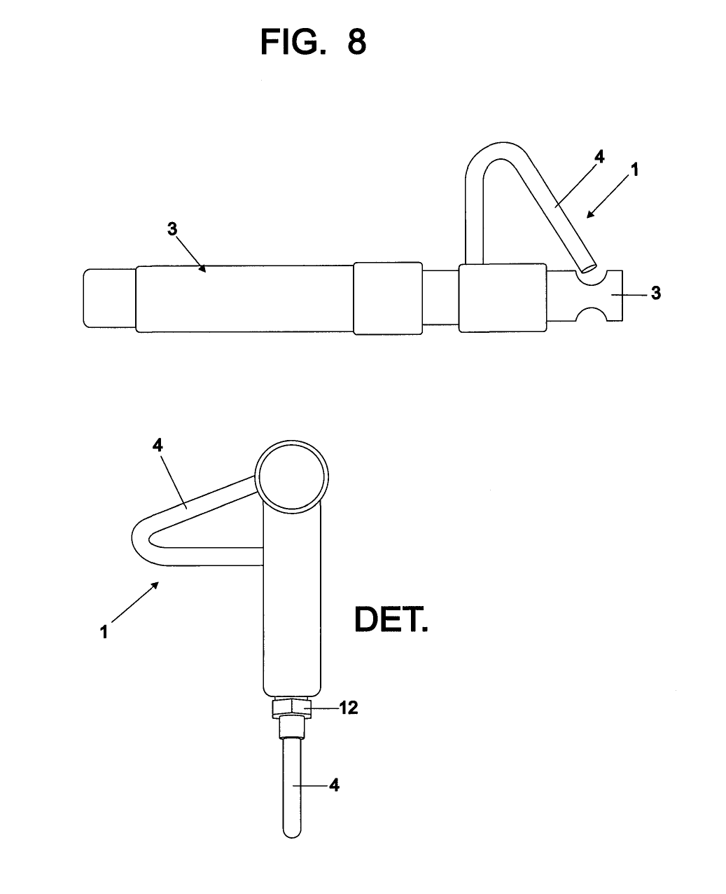

FIG. 8: Upper view of the auxiliary airflow device, innovated and mounted on a pneumatic drill equipped with a micrometer body and a reamer, with air output to the left with details of the rear view;

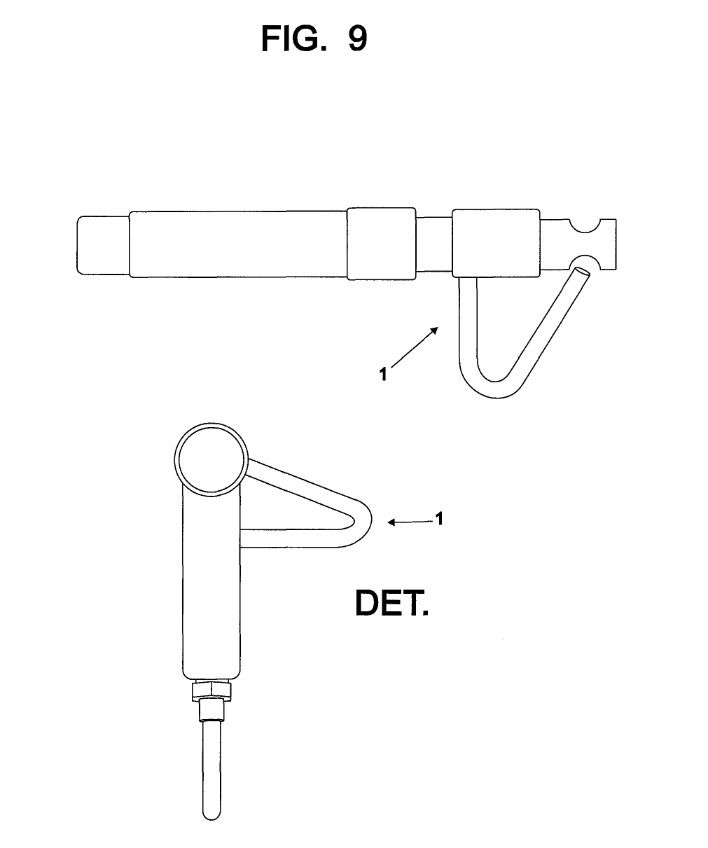

FIG. 9: Upper view of the auxiliary airflow device, innovated and mounted on a pneumatic drill equipped with a micrometer body and a reamer, with air output to the right with details of the rear view;

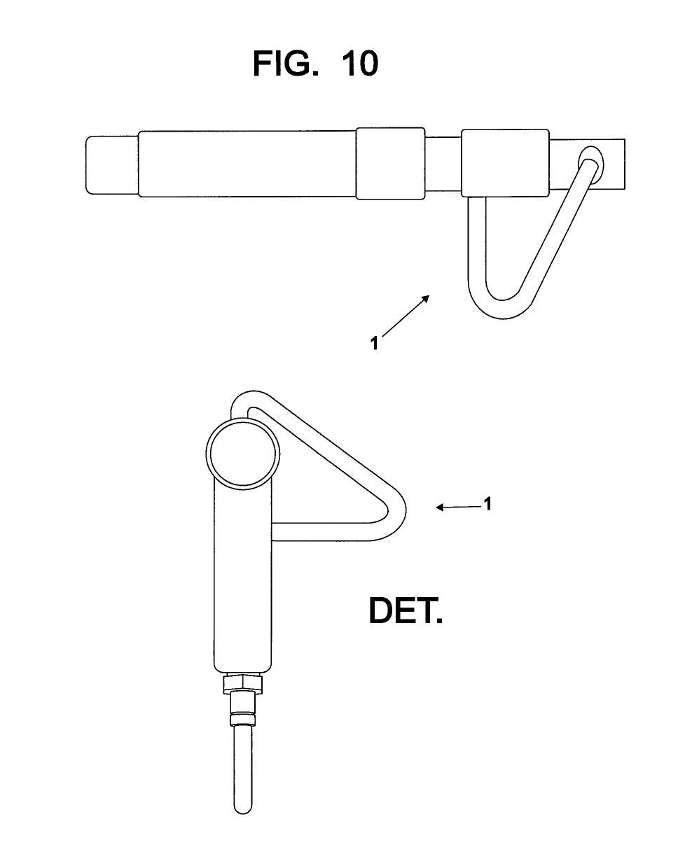

FIG. 10: Upper view of the auxiliary airflow device, innovated and mounted on a pneumatic drill equipped with a micrometer body and a reamer, with air output from the top with details of the rear view;

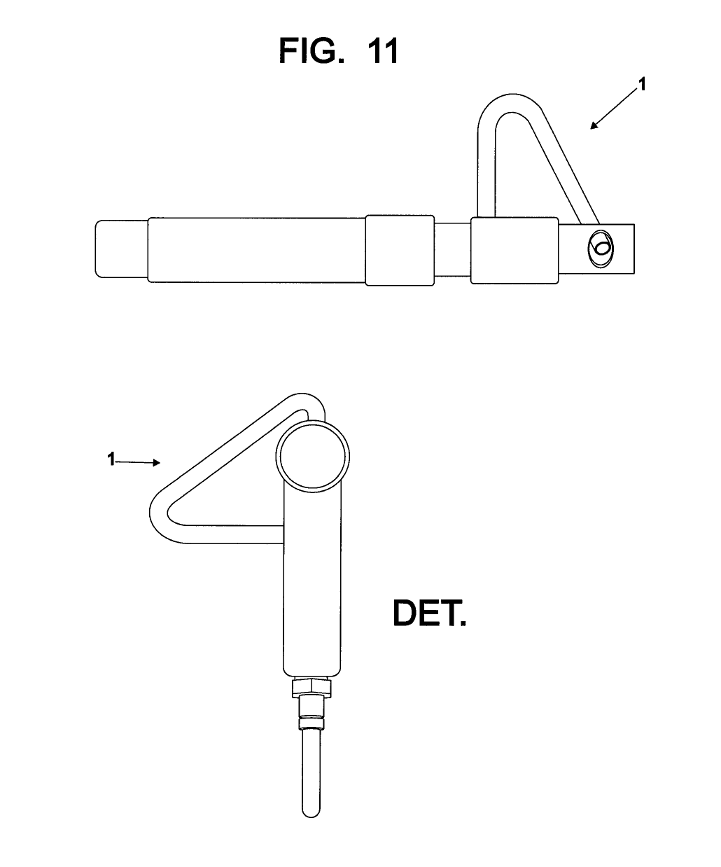

FIG. 11: Upper view of the auxiliary airflow device, innovated and mounted on a pneumatic drill equipped with a micrometer body and a reamer, with air output from the bottom with details of the rear view;

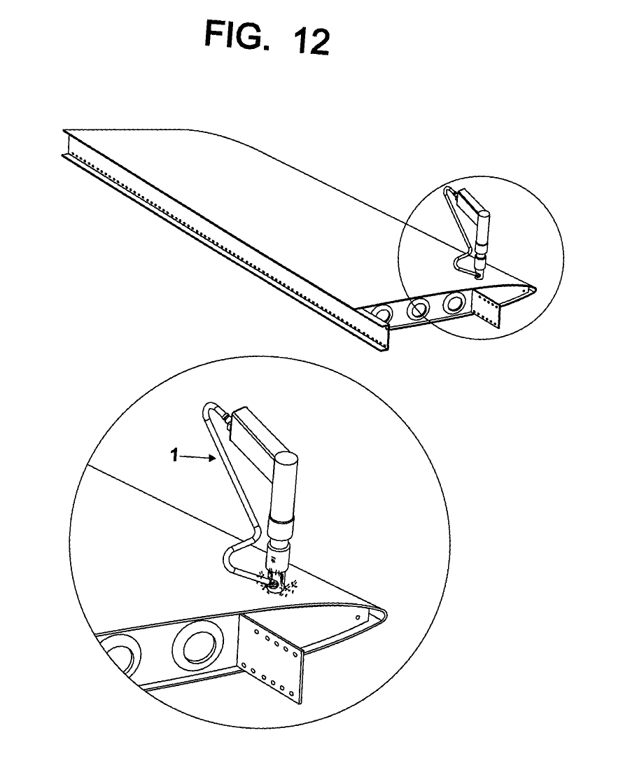

FIG. 12: Perspective view of the auxiliary airflow device, innovated and mounted on a pneumatic drill equipped with a micrometer body and a reamer, showing its use on the wing of an aircraft with air output to the right of the tool;

The auxiliary device for directed air power drills essentially consists of a device (1) connected to the exhaust (2) of pneumatic tools (3) with a duct that (4) directs airflow (A) in the direction of the cutting, drilling or reaming elements (5)/micrometer body (6), removing the residues and consequently increasing their useful life and improving task ergonomics with a substantial reduction in operation time.

More specifically, the device (1) in question is comprised of a duct (4) with length and shape appropriate for the application and/or drilling operation using the drill bit or reaming using the reamer (5). At one of the ends of the duct (4), there is an airtight fitting (7), equipped with a threaded cylinder (8) that terminates (9) with a smooth finishing, that forms a stanchion at the edge (10) in the internal cavity at the exhaust outlet (2) for the pneumatic drill (3). Concentric to this fitting (7) one can observe a split, expandable gasket (11) by applying pressure on an external nut (12), which when squeezed forces the referred to gasket, making it expand and affix to the inside of the aforementioned cavity, thus making it impossible for any air (A) to leak out, forcing it to flow through the duct (4) in the direction of the opposite extremity, which extends to the region of the cutting element, such as, as already mentioned, a drill bit or a reamer (5) with a micrometer body (6). With air blasting action, it is possible to clean or blow away residue generated in the drilling and reaming operation clearing the surface, the cutting element and the micrometer body. Likewise, the connection of the device (1) to the exhaust outlet (2) can be done using the simple threading and tapping between the parts or any other known means for joining them.

The duct (4) may be made, with bends, in several layouts, attending to the different needs for use, such as, following the appropriate outline to spray the airflow with the outlet to the left of the drill (FIG. 6); with the air outlet to the right of the drill (FIG. 8); with the air outlet at the top (FIG. 10) and finally, with the airflow at the bottom (FIG. 11).

In practice, use of the device (1) begin with the operator positioning the pneumatic drill (3), in this case, with the micrometer boy (6) and reamer (5) duly affixed to the mandrill, forming a stanchion on the surface on which the activity will be performed. In this step, the operator chooses the most appropriate duct layout (4) for that situation, to the right, left, up or down. In this context, with the activation of the drill and the start of reaming, all residue, chips and dust generated is outside the cutting elements radius of action by the blast of air from the exhaust outlet through the slits in the micrometer body (6).

Therefore, that is the description and illustration of the best way currently considered to present this patent for a model of utility.

However, it must be understood that, this innovative modification is not limited to the practical aspects of the currently preferred manner, described and illustrated above, and that all such modifications and variations should be considered as being encompassed within the spirit and the scope of this patent for invention.

1. Auxiliary device for directed air power drills, wherein it is comprised of a duct of appropriate length and shape and which at one end has a fitting equipped with a threaded cylinder that ends in a smoothly finished termination, which forms a stanchion at the edge in the internal cavity at the exhaust outlet; concentric to the fitting one can observe an expandable, split gasket which opens by pressing an external nut; the air is blasted from the other end of the duct, towards the cutting element and/or accessory.

2. Auxiliary device for directed air power drills, in accordance with claim 1, wherein the duct can have an air outlet layout to the right, left, up or down in relation to the cutting element.
